(19) United States
(12) Patent Application Publication
(10) Pub. No.: US 2012/0240167 A1
(43) Pub. Date: Sep. 20, 2012

(54) METHOD AND APPARATUS FOR PROVIDING WIRELESS SERVICE USING SCALABLE VIDEO CODING

(76) Inventors: Subramanian Vasudevan, Morristown, NJ (US); Tomas S. Young, Parsippany, NJ (US); Sigen Ye, New Providence, NJ (US)

(21) Appl. No.: 13/173,460

(22) Filed: Jun. 30, 2011

Related U.S. Application Data
(60) Provisional application No. 61/453,525, filed on Mar. 16, 2011.

(51) Int. Cl. H04N 7/16

(52) U.S. Cl. 725/62

(57) ABSTRACT

A multimedia multicast-broadcast coverage capability is disclosed. The multimedia multicast-broadcast coverage capability is configured to provide wireless service coverage for multimedia multicast-broadcast services within an intended service coverage area including a plurality of wireless service regions. The wireless service coverage may be provided using properties of scalable video coding, where, for a given content item, different encoded layers of the content item are appropriately propagated to all or part of the intended coverage area. In one embodiment, a base encoded layer and one or more higher encoded layers, for providing basic and incrementally better quality versions of the content item, are appropriately propagated toward respective sets of the wireless service regions of the intended coverage area. In one embodiment, multiple encoded layers of lower quality are formed, from a content item of higher quality, and propagated toward each of the wireless service regions of the intended coverage area.

### CROSS REFERENCE TO RELATED APPLICATION

This application claims the benefit of U.S. Provisional Patent Application Ser. No. 61/453,525, filed Mar. 16, 2011, which is incorporated herein by reference in its entirety.

### TECHNICAL FIELD

The invention relates generally to communication networks and, more specifically but not exclusively, to supporting services in wireless communication networks.

### BACKGROUND

In many cellular wireless networks, multimedia broadcast-multicast services are used to provide multimedia broadcasting service and multicasting service (e.g., for broadcasting and/or multicasting multimedia content such as television programs, movies, and the like). For example, multimedia broadcast-multicast services may include Multimedia Broadcast Multicast Service (MBMS) (e.g., as supported in existing Global System for Mobile Communications (GSM) and Universal Mobile Telecommunication System (UMTS) cellular networks), Broadcast and Multicast Services (BCMCS) (e.g., as supported in existing Evolution—Data Optimized (EVDO) cellular networks), Evolved MBMS (eMBMS) (e.g., expected to be supported in Long Term Evolution (LTE) cellular networks), and the like.

### SUMMARY

Various deficiencies in the prior art are addressed by embodiments for providing multimedia multicast-broadcast service coverage.

In one embodiment, an apparatus is configured to provide coverage within an intended coverage area for providing delivery of a content item within the intended coverage area, where the intended coverage area includes a plurality of wireless service regions. The apparatus includes a processor configured to propagate a first encoded layer of the content item toward a first set of the wireless service regions of the intended coverage area where the first encoded layer of the content item is associated with a first quality level of the content item, and propagate a second encoded layer of the content item toward a second set of the wireless service regions of the intended coverage area where the second encoded layer of the content item is associated with a second quality level of the content item that is greater than the first quality level of the content item.

In one embodiment, a computer-readable storage medium stores instructions which, when executed by a computer, causes the computer to perform a method for providing coverage within an intended coverage area for providing delivery of a content item within the intended coverage area where the intended coverage area includes a plurality of wireless service regions. The method includes propagating a first encoded layer of the content item toward a first set of the wireless service regions of the intended coverage area where the first encoded layer of the content item is associated with a first quality level of the content item, and propagating a second encoded layer of the content item toward a second set of the wireless service regions of the intended coverage area where the second encoded layer of the content item is associated with a second quality level of the content item that is greater than the first quality level of the content item.

In one embodiment, a method provides coverage within an intended coverage area for providing delivery of a content item within the intended coverage area where the intended coverage area includes a plurality of wireless service regions. The method includes propagating a first encoded layer of the content item toward a first set of the wireless service regions of the intended coverage area where the first encoded layer of the content item is associated with a first quality level of the content item, and propagating a second encoded layer of the content item toward a second set of the wireless service regions of the intended coverage area where the second encoded layer of the content item is associated with a second quality level of the content item that is greater than the first quality level of the content item.

### BRIEF DESCRIPTION OF THE DRAWINGS

The teachings herein can be readily understood by considering the following detailed description in conjunction with the accompanying drawings, in which:

FIG. 1 depicts an exemplary wireless communication system configured to support a multimedia broadcast-multicast service;

FIG. 2 depicts a geographic area including an intended coverage area for a multimedia broadcast-multicast service;

FIGS. 3A-3C depict the geographic area of FIG. 2 for illustrating exemplary embodiments for using multiple encoded layers of a content item to support delivery of the content item to an intended coverage area;

FIG. 4 depicts one embodiment of a method for using multiple encoded layers of a content item to support delivery of the content item to an intended coverage area using a multimedia broadcast-multicast service; and

FIG. 5 depicts a high-level block diagram of a computer suitable for use in performing the functions described herein.

To facilitate understanding, identical reference numerals have been used, where possible, to designate identical elements that are common to the figures.

### DETAILED DESCRIPTION OF ILLUSTRATIVE EMBODIMENTS

In general, a multimedia multicast-broadcast coverage capability is depicted and described herein, although various other capabilities also may be presented herein.

In at least some embodiments, the multimedia multicast-broadcast coverage capability is adapted to provide service coverage for multimedia multicast-broadcast services within an intended service coverage area. The multimedia multicast-broadcast services may include any suitable types of multicast-broadcast services. The service coverage is provided using properties of scalable video coding, where, for a given content item, different encoded layers of the content item are appropriately sent to all or part of the intended coverage area. In one embodiment, for example, a base encoded layer and one or more higher encoded layers, for providing basic and incrementally better quality versions of the content item, are appropriately propagated toward respective sets of the wireless service regions of the intended coverage area. In one embodiment, for example, multiple encoded layers of lower quality are formed, from a content item of higher quality, and propagated toward each of the wireless service regions of the intended coverage area.

The multimedia multicast-broadcast coverage capability may be configured to provide service coverage for the intended service coverage area (including at or near the edge of the intended service coverage area) using less wireless service regions than would otherwise be needed in the absence of the multimedia multicast-broadcast coverage capability.

The multimedia multicast-broadcast coverage capability may be configured to support multiple form factors within the intended service coverage area.

The multimedia multicast-broadcast coverage capability may enable tradeoffs between coverage, efficiency, and/or content quality levels.

Although primarily depicted and described herein with the context of providing multimedia broadcast-multicast services within a cellular wireless network configured to provide multimedia broadcast-multicast services, it will be appreciated that the multimedia multicast-broadcast coverage capability may be adapted to provide service coverage for various other types of services and/or within various other types of networks (which may include cellular and non-cellular wireless networks).

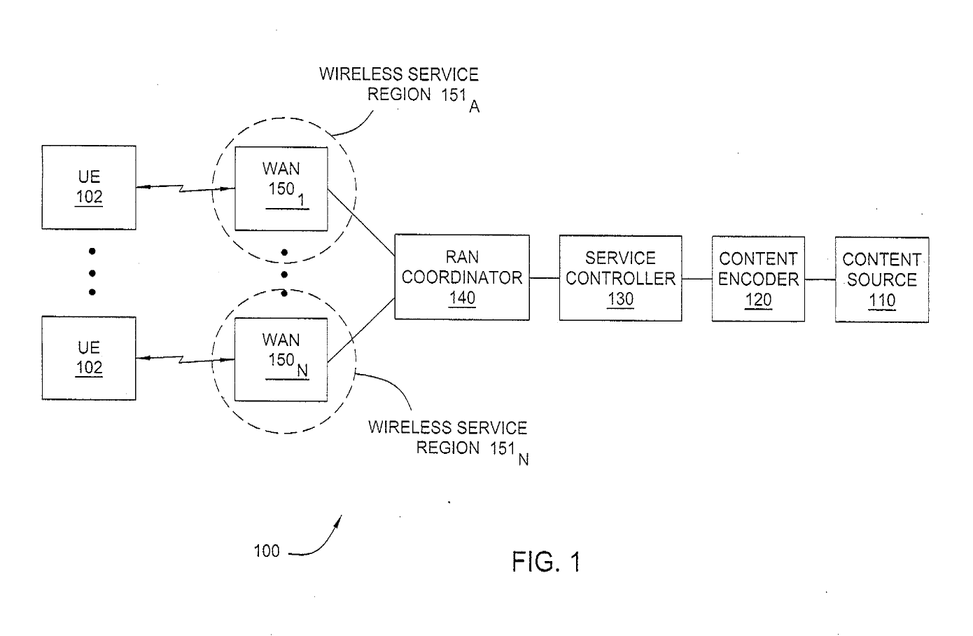

FIG. 1 depicts an exemplary wireless communication system configured to support a multimedia broadcast-multicast service.

The exemplary communication system 100 supports a multimedia multicast-broadcast service configured for providing broadcast service and/or multicast service using various embodiments of the multimedia broadcast-multicast coverage capability. The multimedia multicast-broadcast service may be any suitable type of multimedia multicast-broadcast service, which may depend on the type of wireless network used to provide exemplary communication system 100. For example, the multimedia multicast-broadcast service may be an MBMS service (e.g., as supported in GSM and UMTS wireless networks), a BCMCS service (e.g., as supported in EVDO wireless networks), an eMBMS service (e.g., as expected to be supported in LTE wireless networks), and the like. In one embodiment, in which the multimedia multicast-broadcast service is an eMBMS service, the eMBMS service is provided using an MBMS Single Frequency Network (MBSFN). The multimedia multicast-broadcast service provided by exemplary communication system 100 may include any other suitable type of broadcast and/or multicast service.

The exemplary communication system 100 includes a plurality of User Equipments (UEs) 102 (which also may be referred to herein as user devices (UDs) 102) and a number of network elements cooperating to provide a multimedia broadcast-multicast service to the UEs 102. The network elements include a content source (CS) 110, a content encoder (CE) 120, a service controller (SC) 130, a RAN coordinator (RC) 140, and a plurality of wireless access nodes (WANs) 150₁-150_{N} (collectively, WANs 150).

The UEs 102 receive wireless service from WANs 150. The WANs 150₁-150_{N} provide wireless service to a plurality of wireless service regions 151₁-151_{N} (collectively, wireless service regions 151), respectively. In general, a wireless service region 151 of an associated WAN 150 is a geographic area within which UEs 102 may receive wireless service from the associated WAN 150. In many types of cellular wireless networks, the wireless service regions 151 are referred to as cellular regions or, more generally, as cells.

The CS 110, CE 120, SC 130, RC 140, and WANs 150 are configured to cooperate in a manner for providing a service to UEs 102 in an intended service coverage area (also referred to herein as an intended coverage area). The intended service coverage area for a service may be composed of some or all of the wireless service regions 151 of the WANs 150 which support wireless service for the UEs 102. The service provided to an intended coverage area may include any suitable type of service which may be provided via WANs 150 (e.g., a broadcast service for delivery of broadcast content to UEs 102, a multicast service for delivery of multicast content to UEs 102, and the like, as well as various combinations thereof).

It is noted that, although primarily depicted and described herein with respect to embodiments in which the service is a multimedia broadcast-multicast service for delivery of content to UEs, any other suitable type(s) of service may utilize the capabilities and functions of the multimedia multicast-broadcast coverage capability for providing service coverage within an intended coverage area.

The CS 110 is a source of content which may be provided to UEs 102 using a multimedia broadcast-multicast service. The CS 110 may access the content locally and/or remotely. The content may include various types of content, such as audio content, video content, multimedia content, and the like as well as various combinations thereof. The content may be managed as content items. For example, the content items may include television shows, movies, and the like. The CS 110 may provide content items for delivery to an intended coverage area according to a schedule (e.g., such as where broadcast content is provided according to a predefined broadcast schedule) and/or in response to requests (e.g., such as where content is multicast to a set of UEs 102 after a threshold number of requests for the content are received). In the context of providing the multimedia multicast-broadcast coverage capability for delivering a content item to an intended coverage area, the CS 110 is configured to propagate the content item toward CE 120 for encoding of the content item to form multiple encoded layers of the content item which may be propagated to appropriate portions of the intended coverage area.

The CE 120 is configured to receive the content item from CS 110, process the content item to form multiple encoded layers of the content item, and propagate the multiple encoded layers of the content item toward SC 130 for delivery to UEs 102 via the radio network.

In one embodiment, CE 120 is configured to perform Scalable Video Coding (SVC) for generating the multiple encoded layers of the content item. In SVC encoding, a content item is processed to form multiple encoded layers of the content item, where each encoded layer corresponds to a different quality level of the content item. The multiple encoded layers include a base layer and one or more higher layers. The base layer is a complete version of the content item at the lowest quality level of the content item to be provided (i.e., the receiving device can recover the content item from the base layer by itself without use of any higher layer(s) and, thus, the content item can be presented at the receiver). A higher layer is not a complete version of the content item, but, rather, is combined with the base layer of the content item (and, optionally, one or more other higher layers of the content item) to provide an incrementally higher quality level of the content item (e.g., the decoder combines the base layer and the higher layer(s) to form the version of the content item to be presented at the receiver).

It is noted that any suitable number of higher layers may be supported and, similarly, that any suitable number of higher layers may be combined with the base layer to make available any suitable number of quality levels of the content item. For example, a content item may be SVC encoded to form two encoded layers of the content item (e.g., a base layer and a higher layer), where the base layer corresponds to a low quality version of the content item and a combination of the base layer and the higher layer corresponds to a high quality version of the content item.

For example, a content item may be SVC encoded to form three encoded layers of the content item (e.g., a base layer, a first higher layer, and a second higher layer), where the base layer corresponds to a low quality version of the content item, a combination of the base layer and the first higher layer corresponds to a medium quality version of the content item, and a combination of the base layer, the first higher layer, and the second higher layer corresponds to a high quality version of the content item.

In other words, using SVC encoding, CE 120 produces multiple encoded layers of the content item, starting with the base layer and adding one or more incrementally higher layers with each higher layer (when used in combination with the encoded layers below it) supporting an incrementally better quality version of the content item.

In one embodiment, CE 120 is configured to process an original encoded content item (e.g., encoded using traditional encoding and having an original encoding rate and original quality level associated therewith) to break the original encoded content item into multiple SVC encoded layers. In this embodiment, each of the encoded layers has an associated encoding rate that is lower than the original encoding rate of the original encoded content item (and, thus, each of the encoded layers has an associated quality level that is lower than the original quality level of the original encoded content item). In this embodiment, each of the encoded layers has an associated encoding rate that is low enough such that the encoded layer may be transmitted to all of the wireless service regions of the intended coverage area (e.g., each encoded layer has an associated encoding rate that is less than the highest data rate supported at the outer edge of the intended coverage area, such that each wireless service region of the intended coverage area will be able to receive all of the encoded layers). For example, for an original encoded content item having an original encoding rate of 1 Mbps and intended for an intended coverage area where the wireless service regions at the edge of the cell only support a 500 Kpbs data rate, the encoded content item may be broken into three encoded layers of 500 Kbps, 250 Kbps, and 250 Kbps, such that all three encoded layers are capable of being transmitted to all wireless service regions of the intended coverage area. It is noted that this is merely one example, and that any suitable number of encoded layers having any suitable encoding rates may be formed from the original encoded content item. In this embodiment, whereas the original encoded content item may have an associated original encoding rate that would require use of a Modulation and Coding Scheme (MCS) that is not suitable for providing service coverage at the edge of an intended coverage area, each of the multiple SVC encoded layers may have associated lower encoding rates that enable use of an MCS(s) that is suitable for providing service coverage at the edge of an intended coverage area.

In such embodiments, the CE 120 produces multiple encoded layers of a content item, where each of the encoded layers of the content item may be propagated toward all or part of the intended coverage area.

The SC 130 is configured to perform various functions in support of the multimedia broadcast-multicast coverage capability.

In one embodiment, SC 130 is configured to receive the encoded layers of the content item from CE 120 and propagate the encoded layers of the content item toward appropriate sets of WANs 150.

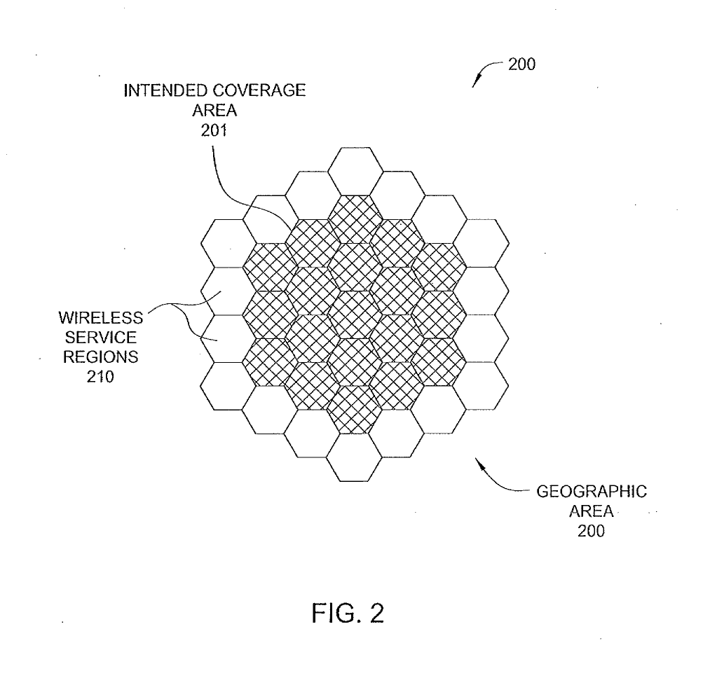

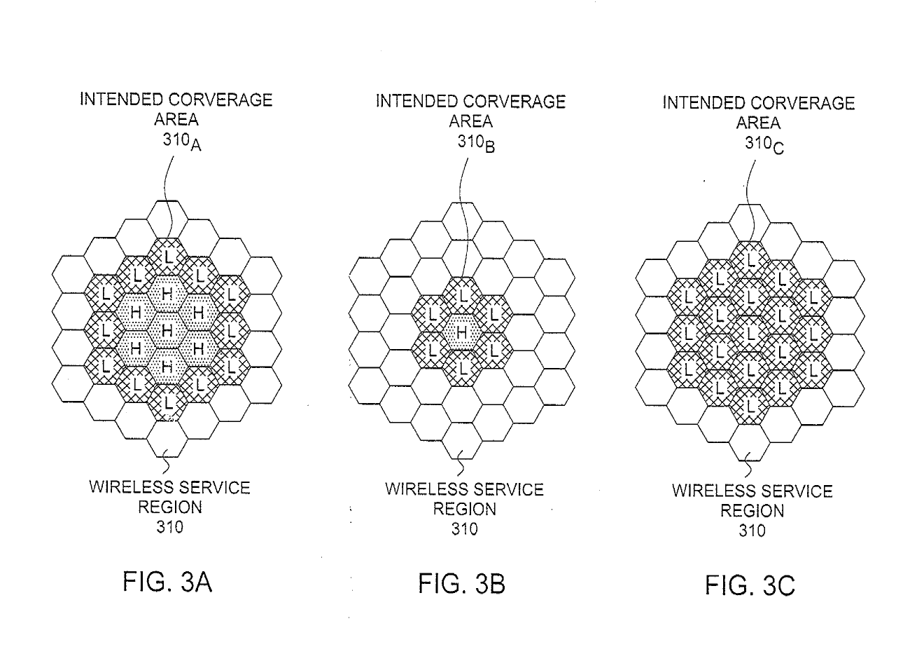

In one embodiment, SC 130 is configured to determine a mapping of each of the encoded layers of the content item to the portions of the intended coverage area to which the encoded layers of the content item are to be sent, respectively. This may include determining, for each of the encoded layers of the content item, the set of the wireless service regions of the intended coverage area to which the encoded layer of the content item is to be propagated. The determination of which of the encoded layers of the content item are propagated to which of the wireless service regions 151 of the intended coverage area may be better understood by way of reference to FIGS. 2 and 3A-3C.

In at least some embodiments, SC 130 also may be configured to provide other functions in support of the multimedia broadcast-multicast coverage capability, such as authorization for UEs 102 requesting activation of multimedia broadcast-multicast service, scheduling and announcement of broadcast and multicast sessions, protection of multimedia broadcast-multicast data, and the like, as well as various combinations thereof.

In one embodiment, at least a portion of the functions depicted and described herein as being performed by CE 120 may be performed by SC 130.

The RC 140 is configured to perform various functions in support of the multimedia broadcast-multicast coverage capability.

In one embodiment, RC 140 is configured to receive the encoded layers of the content item from SC 130 and propagate the encoded layers of the content item toward appropriate sets of WANs 150.

In one embodiment, RC 140 is configured to determine a mapping of each of the encoded layers of the content item to the portions of the intended coverage area to which the encoded layers of the content item are to be sent, respectively. This may include determining, for each of the encoded layers of the content item, the set of the wireless service regions of the intended coverage area to which the encoded layer of the content item is to be propagated. This determination may be performed using local processing, or may be determined via signaling from one or more other elements (e.g., SC 130). The determination of which of the encoded layers of the content item are propagated to which of the wireless service regions 151 of the intended coverage area may be better understood by way of reference to FIGS. 2 and 3A-3C.

In at least some embodiments, RC 140 is configured to provide other functions in support of the multimedia broadcast-multicast coverage capability (e.g., ensuring that the Radio Link Control (RLC)/Medium Access Control (MAC) layers at the WANs 150 are appropriately configured to support a multimedia broadcast-multicast service, ensuring that the same resource block is allocated for a given service across the WANs 150 of a given intended coverage area for the service, deciding details of the radio configuration for delivery of services to UEs 102 (e.g., MCS used to deliver services to UEs 102), participating in MBMS session control signaling, and the like, as well as various combinations thereof).

In one embodiment, at least a portion of the functions depicted and described herein as being performed by SC 130 may be performed by RC 140.

Although primarily depicted and described herein with respect to an embodiment in which RC 140 is located within the data path via which the encoded layers of the content item are transmitted, in one embodiment the RC 140 may be outside of the data path via which the encoded layers of the content item are transmitted. In one embodiment, for example, the encoded layers of the content item are propagated from SC 130 to WANs 150 (e.g., via one or more other elements which are omitted for purposes of clarity), and RC 140 is a control element in communication with WANs 150 and/or SC130 for providing various functions described herein as being performed by RC 140.

The WANs 150 are wireless access nodes providing radio interfaces via which UEs 102 may access the cellular wireless network. The WANs 150 are configured to transmit wirelessly to UEs 102 and receive wirelessly from UEs 102.

The WANs 150₁-150_{N} each receive one or more of the encoded layers of the content item from RC 140 and transmit the received encoded layer(s) of the content item within the wireless service regions 151₁-151_{N}, respectively.

In one embodiment, a WAN 150 is configured to discard packets of higher encoded layers before discarding packets of lower encoded layers when discarding of packets is required or desirable. For example, discarding of packets by a WAN 150 may be performed due to insufficient resources at the WAN 150 (e.g., such as due to demands from unicast traffic or traffic of higher priority broadcast and/or multicast services). This ensures that the base layer (and one or more additional layers if bundled with the base layer) is sent from all of the WANs 150 participating in the multimedia broadcast-multicast service. In the case of MBSFN in an LTE network, for example, this ensures that the base layer (and one or more additional layers if bundled with the base layer) is sent from all of the eNodeBs participating in the MBSFN transmission to thereby ensure sufficient MBSFN gain.

The UEs 102 include wireless user devices configured to receive content via a multimedia broadcast-multicast service. The UEs 102 are configured to access the wireless network via one or more of the WANs 150 (e.g., a UE 102 may communicate with a single WAN 150 at a time or may communicate with multiple WANs 150 at a time). For example, the UEs 102 may include feature phones, smart phones, tablets, laptops, and the like.

In one embodiment, a UE 102 is configured to receive one or more of the encoded layers of the content item (from one or more of the WANs 150), construct a version of the content item from one or more encoded layers of the content item, and present the constructed version of the content item via one or more presentation interfaces of the UE 102.

In an embodiment in which SVC encoding is used, for example, a UE 102 may receive a base encoded layer of the content item and present the content item at a base quality level using the base encoded layer, may receive a base encoded layer and one higher encoded layer of the content item and present the content item at a higher quality level above the base level using a combination of the base and higher encoded layers, and so forth. In this manner, for example, UEs 102 located closer to the center of the intended coverage area are able to receive more encoded layers of the content item than UEs 102 located closer to the edge of the intended coverage area and, thus, UEs 102 located closer to the center of the intended coverage area are able to use the additional encoded layer(s) of the content item to present higher quality versions of the content item than the UEs 102 located closer to the edge of the intended coverage area (which may only receive the base encoded layer or less high encoded layers than the UEs 102 located closer to the center of the intended coverage area).

In an embodiment in which traditional encoding is used to form an original encoded version of the content item and the original encoded version of the content item is processed to break the original encoded version of the content item into multiple encoded layers of the content item, for example, a UE 102 receives the multiple encoded layers of the content item and constructs a version of the content item to be presented at the UE 102 using one or more of the multiple encoded layers of the content item. The number of encoded layers combined by the UE 102 to construct a version of the content item for presentation at the UE 102 may depend on the terminal capabilities of the UE 102 (e.g., processing capabilities and the like). In this manner, for a UE 102 located in a part of the intended coverage area in which it would not have been possible for the UE 102 to receive the original version of the content item, the UE 102 will be able to reconstruct the original version of the content item using the multiple encoded layers of the content item (each of which has an associated encoding rate low enough to be propagated to any point within the intended coverage area) if the UE 102 has terminal capabilities sufficient to reconstruct the original version of the content item from the multiple encoded layers, otherwise the UE 102 will construct an appropriately lower quality version of the content item using a subset of the multiple encoded layers in accordance with its terminal capabilities. In this manner, the multiple encoded layers of the content item enable the content item to be received by different UEs 102, within the intended coverage area, which may support different device form factors (e.g., where different UEs 102 having different device form factors may use the base encoded layer and, where appropriate, one or more additional encoded layers, to construct versions of the content item suitable to the different device form factors of the UEs 102, respectively).

In one embodiment, as indicated above, a UE 102 is configured to reconstruct the content item from two or more encoded layers of the content item received at the UE 102. In this embodiment, due to the potential for inter-stream delay and jitter between the data streams conveying the encoded layers of the content item, the UE 102 is configured to include an amount of memory that is sufficient to provide buffering of multiple data streams in order to accommodate such inter-stream delay and jitter while still enabling all of the encoded layers of the content item to be provided to and processed by the decoder of the UE 102. In one embodiment, the UE 102 is configured to determine the appropriate amount of buffering at the UE by examining the temporal relationship between the different physical broadcast channels transporting the different encoded layers of the content item.

As described herein, SC 130, RC 140, and WANs 150 cooperate to provide propagation of a content item to UEs 102 of an intended coverage area via propagation of encoded layers of the content item to appropriate portions of the intended coverage area. The propagation of encoded layers of a content item may be performed in any suitable manner (e.g., using any suitable types of streams, physical channels, and the like).

With respect to propagation of the encoded layers of a content item, the encoded layers of the content item may be considered to be propagated as individual encoded layers or as sets of encoded layers. In this regard, a “set” may be defined in any suitable manner. In general, a set may be considered to include one or more encoded layers of consecutive quality, and any suitable number of encoded layers of the content item, organized using any suitable number of sets, may be propagated toward an intended coverage area in a manner for providing coverage for the service within the intended coverage area. In one embodiment, for example, a content item is encoded to form four encoded layers, and each of the encoded layers is considered to be propagated toward the intended coverage area as a separate encoded layer. In one embodiment, for example, a content item is encoded to form four encoded layers, and each of the encoded layers is considered to form a single-layer set of encoded layers such that four sets of encoded layers are propagated toward the intended coverage. In one embodiment, for example, a content item is encoded to form six encoded layers (from lowest to highest: A, B, C, D, E, F) and the six encoded layers are organized as two sets of encoded layers (e.g., the first set including encoded layers A, B, and C and the second set including encoded layers D, E, and F). In one embodiment, for example, a content item is encoded to form six encoded layers (from lowest to highest: A, B, C, D, E, F) and the six encoded layers are organized as four sets of encoded layers (e.g., the first set including encoded layer A, the second set including encoded layer B, the third set including encoded layers C and D, and the fourth set including encoded layers E and F). It is noted that an encoded content item may encoded to form any suitable number of encoded layers which may be managed individually and/or organized using any suitable number of sets of encoded layers (each set including any suitable number of encoded layers).

With respect to propagation of the encoded layers of a content item, the encoded layers of the content item may be propagated using any suitable number of physical channels. The propagation of encoded layers of a content item using physical channels may depend, at least in part, on the manner in which the encoded layers of the content item are organized/managed (e.g., as individual encoded layers and/or as sets of encoded layers). In one embodiment, for example, a content item is encoded to form four encoded layers, and each of the encoded layers is considered to be propagated toward the intended coverage area as a separate encoded layer using four separate physical channels. In one embodiment, for example, a content item is encoded to form four encoded layers, and each of the encoded layers is considered to form a single-layer set of encoded layers such that four sets of encoded layers are propagated toward the intended coverage using four separate physical channels. In one embodiment, for example, a content item is encoded to form six encoded layers (from lowest to highest: A, B, C, D, E, F) and the six encoded layers are organized as two sets of encoded layers (e.g., the first set including encoded layers A, B, and C and the second set including encoded layers D, E, and F), where the first set of encoded layers is propagated using a first physical channel and the second set of encoded layers is propagated using a second physical channel. In one embodiment, for example, a content item is encoded to form six encoded layers (from lowest to highest: A, B, C, D, E, F) and the six encoded layers are organized as four sets of encoded layers (e.g., the first set including encoded layer A, the second set including encoded layer B, the third set including encoded layers C and D, and the fourth set including encoded layers E and F), where the four sets of encoded layers are propagated using four physical channels. It is noted that these examples are merely exemplary, and that encoded layers of a content item may be propagated using any suitable number(s) of physical channels.

With respect to propagation of the encoded layers of a content item, the encoded layers of the content item may be transported via any suitable type of content stream(s) using any suitable type(s) of physical channels, one or both of which may vary depending on one of more factors (e.g., technology of the underlying wireless network, type of content to be transported, and the like, as well as various combinations thereof). For example, each encoded layer or set of encoded layers may be carried over a physical broadcast channel (e.g., a Physical Multicast Channel (PMCH) as used in various cellular networks, or any other suitable type of physical channel). For example, each encoded layer or set of encoded layers for a given physical broadcast channel may be carried over its own associated content stream (e.g., a Real-Time Transport Protocol (RTP) stream, a Stream Control Transmission Protocol (SCTP) stream, and the like). It is noted that multiple PMCHs may be accommodated within a single MBSFN area, or within overlapping MBSFN areas where UEs 102 are configured to support multiple MBSFN areas simultaneously. It is noted that any other suitable type(s) of channels and/or suitable type(s) of streams may be used to propagate encoded layers of a content item toward an intended coverage area.

As noted herein, in addition to using multiple encoded layers of a content item in order to provide the multimedia broadcast-multicast coverage capability for a multimedia broadcast-multicast service, various other capabilities may be implemented in order to provide the multimedia broadcast-multicast coverage capability for a multimedia broadcast-multicast service.

In one embodiment, signaling capabilities are provided for conveying service-related information toward the radio network. In one embodiment, for example, for a given content item to be propagated or being propagated to an intended coverage area using multiple encoded layers of the content item, the service-related information may include one or more of identification of the sets of wireless service regions to which each of the encoded layers of the content item is to be propagated, information indicative of the quality levels supported by the respective encoded layers of the content item, and the like, as well as various combinations thereof. This service-related information may be determined and/or signaled by one or more of SC 130, RC 140, and WANs 150. This type of information may be used by the radio network (e.g., RC 140 and/or WANs 150) to assign and deliver multiple content streams over multiple physical broadcast channels. This type of information also may be used by the UEs 102 for reconstructing the content item from multiple encoded layers of the content item received at the UEs 102. This type of signaling may be supported in any suitable manner (e.g., by using MBMS signaling interfaces supporting MBMS operation in a UMTS MBMS system, by using eMBMS signaling interfaces supporting eMBMS operation in an LTE eMBMS system, and the like). Within the context of FIG. 1, for example, this type of signaling may be supported by SC 130, RC 140, WANs 150, and the associated signaling interfaces between these elements.

In one embodiment, signaling capabilities are provided for conveying service-related feedback information from the radio network toward CE 120. In one embodiment, for example, for a given content item to be propagated or being propagated to an intended coverage area using multiple encoded layers of the content item, the service-related feedback information may include one or more of UE capability information indicative of the terminal capabilities of the UEs 102, transmission requirements of the radio network (e.g., supported data rates within the intended coverage area and like information), and the like, as well as various combinations thereof. The service-related feedback information may originate from one or more of UEs 102, WANs 150, RC 140, and SC 130. In one embodiment, the service-related feedback information is used by WANs 150 and/or RC 140 to control assignment and delivery of content streams over physical broadcast channels. In one embodiment, the service-related feedback information is used by CE 120 to generate the multiple encoded layers of the content item to be provided to the intended coverage area (e.g., to determine the number of encoded layers of the content item to be used, to determine the associated encoding rates of the encoded layers of the content item to be used, and the like). This type of signaling may be supported in any suitable manner (e.g., by using MBMS signaling interfaces supporting MBMS operation in a UMTS MBMS system, by using eMBMS signaling interfaces supporting eMBMS operation in an LTE eMBMS system, and the like). Within the context of FIG. 1, for example, this type of signaling may be supported by UEs 102, WANs 150, RC 140, SC 130, and CE 120.

In one embodiment, service information is propagated to the UEs 102. In one embodiment, for example, for a given content item to be propagated to an intended coverage area using multiple encoded layers of the content item, the service information may include association of the multiple encoded layers of the content item as being part of a single available service which may be announced within the intended coverage area such that UEs 102 are aware of the service and may access the service. In one embodiment, the service information also may include other types of information associated with the multiple encoded layers of the content item (e.g., identification of the encoded layers of the content item from lowest to highest quality, information regarding the encoding rates of the encoded layers of the content item, information regarding the type(s) of MCS used for the encoded layers of the content item, and the like, as well as various combinations thereof). This type of service information may be propagated in any suitable form. In one embodiment, for example, this type of announcement may be provided as part of a service guide associated with the service via which the content item is made available (e.g., an Electronic Programming Guide (EPG) or similar television-type guide where the content item is a television program, a movie on-demand service guide where the content item is a movie, and the like). This type of service information may be propagated using any suitable signaling capabilities. Within the context of FIG. 1, for example, this type of service information may be propagated from SC 130 toward the UEs 102 via RC 140 and WANs 150.

As described herein, the multimedia broadcast-multicast coverage capability may be provided within any suitable type of wireless network and, thus, the SC 130, RC 140, and WANs 150 may be associated with any suitable type of cellular network. In one embodiment, for example, these elements are implemented as part of the multicast-broadcast portion of a UMTS wireless network (e.g., where SC 130 is a Broadcast-Multicast Service Center (BMSC), RC 140 is a Radio Network Controller (RNC), and WANs 150 are NodeBs). In one embodiment, for example, these elements are implemented as part of a multicast-broadcast portion of an LTE wireless network (e.g., where SC 130 is a BMSC, RC 140 is an MBMS Coordination Entity (MCE), and WANs 150 are eNodeBs). These elements may be implemented within any other suitable type of wireless network (using any suitable elements of the wireless network) configured to support a multimedia broadcast-multicast service.

As described herein, the multimedia multicast-broadcast service has an intended coverage area associated therewith. The intended coverage area may be considered to cover a particular geographic area and, similarly, may be considered to be composed of a group of wireless service regions located within that particular geographic region. For example, in exemplary communication system 100 of FIG. 1, the wireless service regions of the intended coverage area may be considered to include at least a portion of the wireless service regions 151 covered by WANs 150, respectively. An exemplary intended coverage area is depicted in additional detail with respect to FIG. 2.

FIG. 2 depicts a geographic area including an intended coverage area for a multimedia broadcast-multicast service.

As depicted in FIG. 2, a geographic area 200 includes thirty seven wireless service regions 210 arranged in a honeycomb pattern. The thirty-seven wireless service regions 210 receive wireless service from thirty-seven WANs associated therewith (which are omitted from FIG. 2 for purposes of clarity).

As further depicted in FIG. 2, geographic area 200 includes an intended coverage area 201, which includes the nineteen wireless service regions 210 located toward the center of the geographic area 200 and excludes the eighteen wireless service regions 210 forming the outer edge of the geographic area 200. This intended coverage area 201 corresponds to an area within which the wireless service provider intends to provide coverage for the multimedia broadcast-multicast service (e.g., an area within which the wireless service provider intends to use a broadcast-multicast service to make a particular content item available to end users).

As described herein, embodiments of the multimedia broadcast-multicast coverage capability provide coverage for the multimedia broadcast-multicast service within an intended coverage area in a manner obviating a need to utilize cell layering in order to support the service within the intended coverage area. In general, cell layering is the use of additional cells surrounding an intended coverage area in order to provide service within the intended coverage area. For example, cell layering may be used due to the interference that is normally encountered due to wireless transmissions from neighbor cells that are not part of the intended coverage area but which interfere with the edge of the intended coverage area. The type of cell layering that is obviated by the multimedia broadcast-multicast coverage capability may be understood from FIG. 2. For example, using cell layering and in the absence of the multimedia broadcast-multicast coverage capability, a service would need to be transmitted to all thirty-seven wireless service regions 210 of geographic area 200 in order to provide adequate service coverage in the intended coverage area 201 defined to include only the nineteen cells at the center of geographic area 200. As may be seen from this example, use of cell layering clearly does not provide an efficient use of resources, particularly air interface resources (e.g., without use of the multimedia broadcast-multicast coverage capability, the service would need to be transmitted by each of the eighteen wireless service regions 201 located around the edge of the geographic area 200 even though the service is not intended to be made available within those eighteen wireless service regions 210). In synchronized transmission areas (e.g., MBSFN areas providing MBMS/eMBMS service), for example, this is true for both small synchronized transmission areas (e.g., where the ratio of the synchronized transmission area to intended coverage area is low) and for large synchronized transmission areas (e.g., where the number of cells in the outmost cell layer is large).

As described herein, embodiments of the multimedia broadcast-multicast coverage capability provide coverage for the multimedia broadcast-multicast service within the intended coverage area 201 by propagating multiple encoded layers of the content item toward wireless service regions 210 of the intended coverage area 201.

The manner in which multiple encoded layers of a content item may be used to provide coverage for the multimedia broadcast-multicast service within the intended coverage area 201 of FIG. 2 may be better understood by considering the exemplary embodiments of the multimedia broadcast-multicast coverage capability depicted and described with respect to FIGS. 3A-3C.

FIGS. 3A-3C depict the geographic area of FIG. 2 for illustrating exemplary embodiments for using multiple encoded layers of a content item to support delivery of the content item to an intended coverage area.

In one embodiment, as depicted in FIGS. 3A and 3B, a first encoded layer of the content item is propagated toward each of the wireless service regions of the intended coverage area and a second encoded layer of the content item is propagated toward a subset of the wireless service regions of intended coverage area located closer to the center of intended coverage area. In this embodiment, the first encoded layer is the base encoded layer (i.e., the lowest quality level) and the second encoded layer is a higher encoded layer (i.e., having a higher quality level than the quality level of the base encoded layer).

In one embodiment, as depicted in FIG. 3A, the subset of wireless service regions toward which the second encoded layer is propagated includes a plurality of wireless service regions. In the example of FIG. 3A, the intended coverage area 301_{A} is identical to the intended coverage area 201 of FIG. 2 (illustratively, intended coverage area 301_{A} includes nineteen wireless service regions 310 located toward the center of the geographic area 200). In this example, the first encoded layer of the content item is propagated to all nineteen of the wireless service regions 310 of the intended coverage area 301_{A}, and the second encoded layer of the content item is only propagated toward the seven wireless service regions 310 located near the center of the intended coverage area 301_{A}. The UEs 102 located within the twelve wireless service regions 310 located at the edge of the intended coverage area 301_{A} receive only the first encoded layer and, thus, are able to receive the lowest quality version of the content item. The UEs 102 located within the seven wireless service regions 310 located near the center of the intended coverage area 301_{A} receive both the first and second encoded layers and, thus, are able to construct a higher quality version of the content item using the two encoded layers. In this example, assuming transmission of the higher quality version of the content item, absence of the multimedia broadcast-multicast coverage capability would result in a situation in which UEs 102 located within the twelve wireless service regions 310 at the edge of the intended coverage area 301_{A} would not receive any service (and, thus, would not receive the content item).

In one embodiment, as depicted in FIG. 3B, the subset of wireless service regions toward which the second encoded layer is propagated includes a single wireless service region. In the example of FIG. 3B, the intended coverage area 301_{B} is smaller than the intended coverage area 201 of FIG. 2 (illustratively, intended coverage area 301 includes only the seven wireless service regions 310 located toward the center of the geographic area 200). In this example, the first encoded layer of the content item is propagated to all seven of the wireless service regions 310 of the intended coverage area 310_{B}, and the second encoded layer of the content item is only propagated toward the one wireless service region 310 located near the center of the intended coverage area 301₈. The UEs 102 located within the six wireless service regions 310 located at the edge of the intended coverage area 301_{B} receive only the first encoded layer and, thus, are able to receive the lower quality version of the content item. The UEs 102 located within the single wireless service region 310 located near the center of the intended coverage area 301_{B} receive both the first and second encoded layers and, thus, are able to construct a higher quality version of the content item using the two encoded layers. In this example, assuming transmission of the content item in a manner for ensuring that UEs 102 located within each of the seven wireless service regions 310 of the intended coverage area 301 can receive the content item, absence of the multimedia broadcast-multicast coverage capability would result in a situation in which all UEs 102 within the intended coverage area 301_{B} would be constrained by the UEs 102 located at the outer edge of the intended coverage area 301_{B} (i.e., transmission of the content item would be constrained to be transmission of a lower quality version of the content item even though UEs 102 located near the center of the intended coverage area would be able to receive a higher quality version of the content item).

In one embodiment, as depicted in FIG. 3C, multiple encoded layers of the content item are propagated toward each of the wireless service regions of the intended coverage area. This embodiment may be used, for example, where the CE 120 process an original encoded content item (having a original quality level associated therewith) to break the original encoded content item into multiple SVC encoded layers (each having an associated quality level that is lower than the original quality level of the original encoded content item). In this embodiment, each of the UEs 102 within the intended coverage area receives each of the multiple (lower quality) encoded layers of the content item and uses one or more of the multiple (lower quality) encoded layers of the content item to present the content item. In the example of FIG. 3C, the intended coverage area 301_{C} is identical to the intended coverage area 201 of FIG. 2 (illustratively, intended coverage area 301_{C} includes nineteen wireless service regions 310 located toward the center of the geographic area 200). In this example, each of the multiple encoded layers of the content item is propagated to all nineteen of the wireless service regions 310 of the intended coverage area 301_{C}, and each of the UEs 102 located in the intended coverage area 301_{C} is able to use one or more of the encoded layers of the content item to present a version of the content item. In this example, a UE 102 located anywhere in the intended coverage area may be able to present any version of the content item which may be constructed from the multiple encoded layers of the content item, depending on the terminal capabilities of the UE 102. As a result, in this example, a UE 102 located anywhere in the intended coverage area 301_{C} may be able to present the original version of the content item (even those UEs 102 that are located in the twelve wireless service regions 310 within which the UEs 102 would not have been able to receive the original version of the content item had it been propagated in that form), as long as the UE 102 is capable of processing all of the multiple encoded layers of the content item to recreate the original version of the content item, otherwise the UE 102 will construct an appropriately lower quality version of the content item using a subset of the multiple encoded layers in accordance with its terminal capabilities. In this manner, the multiple encoded layers of the content item may be used within the intended coverage area to provide coverage for multiple device form factors (e.g., where different UEs 102 having different device form factors may use the base encoded layer and, where appropriate, one or more additional encoded layers, to construct versions of the content item suitable to the different device form factors of the UEs 102, respectively). As described herein, the multiple encoded layers may be transported via one or more SVC content streams, and it noted, that where a single SVC content stream is used to transport each of the multiple encoded layers, the amount of resources necessary to support multiple device form factors within the intended coverage area is significantly reduced (e.g., by obviating a need for encoding of multiple complete content streams at respective data rates that are tailored to respective individual device form factors of UEs 102 within the intended coverage area, where the encoding overhead of producing multiple encoded layers is significantly less than the encoding overhead of producing multiple content streams). In this example, without use of the multimedia broadcast-multicast coverage capability, the original encoded content item would be propagated toward the intended coverage area 301_{C}, and (1) would only be received by UEs 102 in the inner portion of the intended coverage area 301_{C} (e.g., UEs 102 in the seven wireless service regions 310 in the inner portion of the intended coverage area 301_{C}) in which the associated data rate is sufficient to support the original encoding rate of the original encoded content item, and (2) would not be received by UEs 102 in the outer portion of the intended coverage area 301_{C} (e.g., the twelve wireless service regions 310 forming the outer edge of the intended coverage area 301_{C}) in which the associated data rate is too small to support the original encoding rate of the original encoded content item.

It is noted that, although primarily depicted and described with respect to use of two encoded layers of a content item to provide two content quality levels within an intended service area, any suitable number of encoded layers of a content item may be used to provide any suitable number of content quality levels within an intended service area.

In one embodiment, for example, a content item may be SVC encoded to form four encoded layers of the content item (e.g., a base encoded layer and first, second, and third higher encoded layers) organized as a first set of encoded content layers (including the base encoded layer and the first higher encoded layer) and a second set of encoded content layers (including the second and third higher encoded layers), where the first set of encoded content layers is propagated toward a first set of wireless service regions including all wireless service regions of the intended coverage area and the second set of encoded content layers is propagated toward a second set of wireless service regions including a subset of the wireless service regions of the first set of wireless service regions. Within the context of the geographic area 200 and intended coverage area 201 of FIG. 2, for example, the first set of wireless service regions may include the nineteen wireless service regions located nearest the center of intended coverage area 201, and the second set of wireless service regions may include the seven wireless service regions located nearest the center of intended coverage area 201.

In one embodiment, for example, a content item may be SVC encoded to form three encoded layers of the content item (e.g., a base encoded layer and first and second higher encoded layers), where the base encoded layer is propagated toward a first set of wireless service regions including all wireless service regions of the intended coverage area, the first higher encoded layer is propagated toward a second set of wireless service regions including a subset of the wireless service regions of the first set of wireless service regions, and the second higher encoded layer is propagated toward a third set of wireless service regions including a subset of the wireless service regions of the second set of wireless service regions. Within the context of the geographic area 200 and intended coverage area 201 of FIG. 2, for example, the first set of wireless service regions may include the nineteen wireless service regions located nearest the center of intended coverage area 201, the second set of wireless service regions may include the seven wireless service regions located nearest the center of intended coverage area 201, and the third set of wireless service regions may include the one wireless service region located at the center of intended coverage area 201.

In one embodiment, for example, a content item may be SVC encoded to form six encoded layers of the content item (e.g., a base encoded layer and five higher encoded layers) organized as a first set of encoded content layers (including the base encoded layer and the first higher encoded layer) that is propagated toward a first set of wireless service regions including all wireless service regions of the intended coverage area, a second set of encoded content layers (including the second and third higher encoded layers) that is propagated toward a second set of wireless service regions including a subset of the wireless service regions of the first set of wireless service regions, and a third set of encoded content layers (including the fourth and fifth higher encoded layers) that is propagated toward a third set of wireless service regions including a subset of the wireless service regions of the second set of wireless service regions. Within the context of the geographic area 200 and intended coverage area 201 of FIG. 2, for example, the first set of wireless service regions may include the nineteen wireless service regions located nearest the center of intended coverage area 201, the second set of wireless service regions may include the seven wireless service regions located nearest the center of intended coverage area 201, and the third set of wireless service regions may include the one wireless service region located at the center of intended coverage area 201.

Thus, more generally and as noted above, any suitable number of encoded layers of a content item (which may be organized as any suitable number of sets of encoded layers of the content item) may be used to provide any suitable number of content quality levels within an intended service area.

In this manner, various embodiments of the multimedia broadcast-multicast coverage capability are configured to extend service coverage with graceful degradation in the direction from the center of the intended coverage area toward the edge of the intended coverage area, without relying on the use of additional wireless service regions to provide coverage within a given intended coverage area and without limiting the quality level of the entire intended coverage area to the worst case associated with the edge of the intended coverage area. As a result, UEs 102 may experience better quality as they move toward the center of the intended coverage area and are able to more reliably receive higher MCS transmissions.

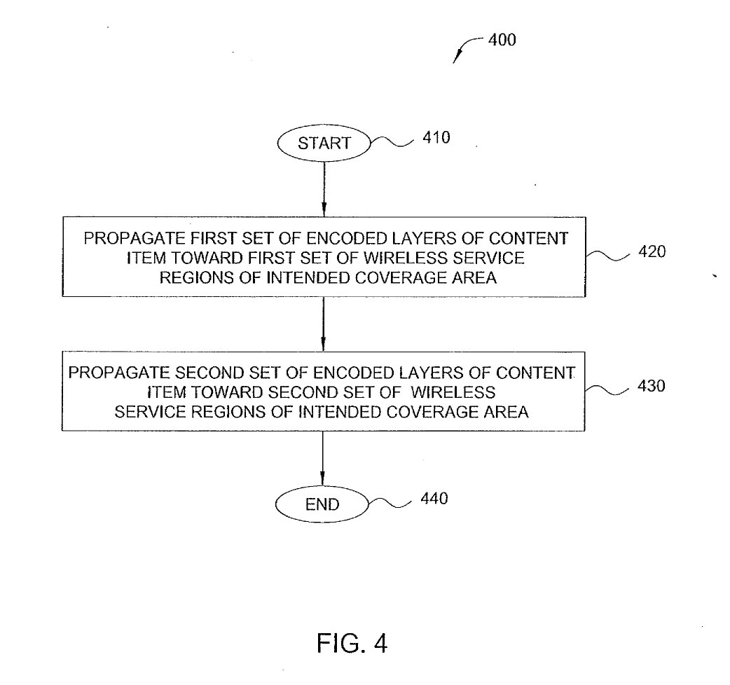

FIG. 4 depicts one embodiment of a method for using multiple encoded layers of a content item to support delivery of the content item to an intended coverage area using a multimedia broadcast-multicast service.

It is noted that method 400 of FIG. 4 may be executed by any suitable network element in the data path between the content source and the WANs via which the encoded layers of the content item are wirelessly transmitted. For example, method 400 of FIG. 4 may be executed by SC 130, RC 140, or any other suitable network element.

It is noted that although the steps of method 400 of FIG. 4 are primarily depicted and described herein as being performed serially, the steps of method 400 may be performed contemporaneously and/or in a different order than presented.

At step 410, method 400 begins.

At step 420, a first set of encoded layers of the content item is propagated toward a first set of wireless service regions of the intended coverage area.

At step 430, a second set of encoded layers of the content item is propagated toward a second set of wireless service regions of the intended coverage area.

At step 440, method 400 ends.

It is noted that the multimedia multicast-broadcast coverage capability may be used in combination with one or more other techniques in order to further improve service coverage and/or efficiency for a multimedia multicast-broadcast service (e.g., reducing power during MBSFN sub-frames from other MBSFN intended coverage areas, reducing power during MBSFN sub-frames from neighboring wireless service regions that are unrelated to providing the eMBMS service, and the like, as well as various combinations thereof).

it is noted that use of relative terms herein (e.g., “base,” “original,” “low,” “high,” “lower,” “higher, and the like) is meant to denote a relative difference in the associated characteristic for which the terms are used (e.g., quality level, encoding rate, and the like) and, thus, do not indicate any particular absolute values for these terms.

Although primarily depicted and described herein with respect to embodiments for providing coverage for specific types of broadcast-multicast services, it is noted that various functions of the multimedia multicast-broadcast coverage capability may be used to provide coverage for other types of multimedia broadcast-multicast services.

Although primarily depicted and described herein with respect to embodiments for providing coverage for broadcast-multicast services, it is noted that various functions of the multimedia multicast-broadcast coverage capability may be used to provide coverage for broadcast-only services and multicast-only services.

Although primarily depicted and described herein with respect to embodiments for providing coverage for broadcast-multicast services, it is noted that various functions of the multimedia multicast-broadcast coverage capability may be used to provide coverage for other suitable types of services (i.e., other than broadcast and multicast services).

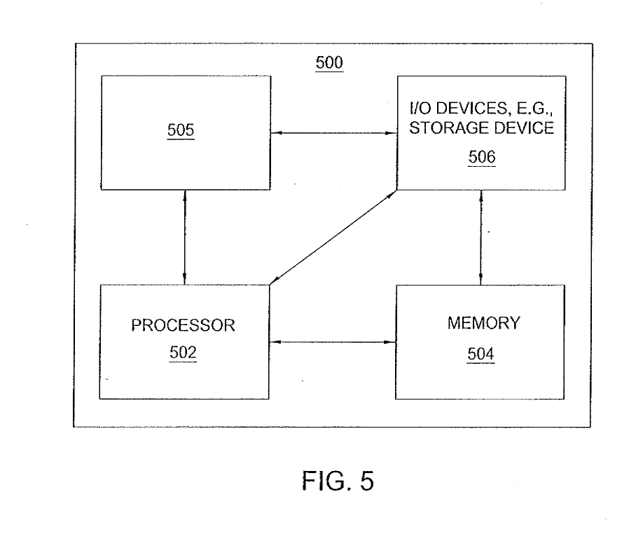

FIG. 5 depicts a high-level block diagram of a computer suitable for use in performing functions described herein.

As depicted in FIG. 5, computer 500 includes a processor element 502 (e.g., a central processing unit (CPU) and/or other suitable processor(s)) and a memory 504 (e.g., random access memory (RAM), read only memory (ROM), and the like). The computer 500 also may include a cooperating module/process 505 and/or various input/output devices 506 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software (e.g., via implementation of software on one or more processors) and/or hardware (e.g., using a general purpose computer, one or more application specific integrated circuits (ASIC), and/or any other hardware equivalents).

It will be appreciated that the functions depicted and described herein may be implemented in software for executing on a general purpose computer (e.g., via execution by one or more processors) so as to implement a special purpose computer, and/or may be implemented in hardware (e.g., using one or more application specific integrated circuits (ASIC) and/or one or more other hardware equivalents).

In one embodiment, the cooperating process 505 can be loaded into memory 504 and executed by processor 502 to implement functions as discussed herein. Thus, cooperating process 505 (including associated data structures) can be stored on a computer readable storage medium, e.g., RAM memory, magnetic or optical drive or diskette, and the like.

It will be appreciated that computer 500 depicted in FIG. 5 provides a general architecture and functionality suitable for implementing functional elements described herein and/or portions of functional elements described herein. For example, the computer 500 provides a general architecture and functionality suitable for implementing one or more of a UE 102, a portion of a UE 102, a CS 110, a portion of a CS 110, a CE 120, a portion of a CE 120, an SC 130, a portion of an SC 130, an RC 140, a portion of an RC 140, a WAN 150, a portion of a WAN 150, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus for providing a content item within an intended coverage area comprising a plurality of wireless service regions, the apparatus comprising:
a processor configured to:
propagate a first encoded layer of the content item toward a first set of the wireless service regions of the intended coverage area, wherein the first encoded layer of the content item is associated with a first quality level of the content item; and
propagate a second encoded layer of the content item toward a second set of the wireless service regions of the intended coverage area, wherein the second encoded layer of the content item is associated with a second quality level of the content item that is greater than the first quality level of the content item.

2. The apparatus of claim 1, wherein the first set of the wireless service regions of the intended coverage area comprises all of the wireless service regions of the intended coverage area.

3. The apparatus of claim 2, wherein the second set of the wireless service regions of the intended coverage area is a subset of the wireless service regions of the intended coverage area.

4. The apparatus of claim 2, wherein the second set of the wireless service regions of the intended coverage area comprises all of the wireless service regions of the intended coverage area.

5. The apparatus of claim 1, wherein the content item is encoded using scalable video coding (SVC).

6. The apparatus of claim 5, wherein the first encoded layer of the content item is a base layer of the SVC encoded content item, wherein the second encoded layer of the content item is a higher layer of the SVC encoded content item.

7. The apparatus of claim 1, wherein the processor is configured to:
receive the content item; and
process the content item using scalable video coding (SVC) to form the first and second encoded layers of the content item.

8. The apparatus of claim 1, wherein the processor is configured to:
receive an original version of the content item having an original encoding rate associated therewith; and
process the original version of the content item to form a plurality of encoded layers of the content item, the plurality of encoded layers of the content item including the first and second encoded layers, the first and second encoded layers having respective first and second encoding rates less than the original encoding rate.

9. The apparatus of claim 1, wherein the first encoded layer of the content item is propagated using a first Modulation and Coding Scheme (MCS) and the second encoded layer of the content item is propagated using a second MCS.

10. The apparatus of claim 1, wherein the first and second encoded layers of the content item are propagated using one or more scalable video coding (SVC) content streams.

11. The apparatus of claim 1, wherein the first and second encoded layers of the content item are propagated via one or more physical broadcast channels.

12. The apparatus of claim 1, wherein the processor is configured to:
propagate a third encoded layer of the content item toward the first set of wireless service regions of the intended coverage area, wherein the third encoded layer of the content item is associated with a third quality level of the content item that is greater than the first quality level and less than the second quality level.

13. The apparatus of claim 1, wherein the processor is configured to:
propagate a third encoded layer of the content item toward the second set of wireless service regions of the intended coverage area, wherein the third encoded layer of the content item is associated with a third quality level of the content item that is greater than the first quality level and greater than or less than the second quality level.

14. The apparatus of claim 1, wherein the processor is configured to:
propagate a third encoded layer of the content item toward a third set of wireless service regions of the intended coverage area, wherein the third set of wireless service regions is a subset of the wireless service regions of the second set of wireless service regions, wherein the third encoded layer of the content item is associated with a third quality level of the content item that is greater than the first and second quality levels.

15. The apparatus of claim 1, wherein the first and second sets of wireless service regions are associated with a radio network, wherein the processor is configured to:
propagate, toward the radio network, a mapping of the first and second encoded layers to the respective first and second sets of wireless service regions to which the first and second encoded layers are to be propagated.

16. The apparatus of claim 1, wherein the first and second encoded layers are formed by a content encoder, wherein the processor is configured to:
propagate, toward the content encoder, information indicative of one or more data rates supported within the intended coverage area.

17. The apparatus of claim 1, wherein the first and second encoded layers are associated with a service, wherein the processor is configured to:
propagate, toward user devices of the intended coverage area, information comprising information identifying association of the first and second encoded layers with the service and information indicative of the first and second quality levels of the first and second encoded layers.

18. The apparatus of claim 1, wherein the processor forms part of a wireless access node, wherein the processor is configured to prefer discarding of packets transporting the second encoded layer to discarding of packets transporting the first encoded layer.

19. The apparatus of claim 1, wherein the processor is implemented within one of a content encoder, a service controller, and a Radio Access Network (RAN) coordinator.

20. A computer-readable storage medium storing instructions which, when executed by a computer, cause the computer to perform a method for providing a content item within an intended coverage area comprising a plurality of wireless service regions, the method comprising:
propagating a first encoded layer of the content item toward a first set of the wireless service regions of the intended coverage area, wherein the first encoded layer of the content item is associated with a first quality level of the content item; and
propagating a second encoded layer of the content item toward a second set of the wireless service regions of the intended coverage area, wherein the second encoded layer of the content item is associated with a second quality level of the content item that is greater than the first quality level of the content item.

21. A method for providing a content item within an intended coverage area comprising a plurality of wireless service regions, the method comprising:
propagating a first encoded layer of the content item toward a first set of the wireless service regions of the intended coverage area, wherein the first encoded layer of the content item is associated with a first quality level of the content item; and
propagating a second encoded layer of the content item toward a second set of the wireless service regions of the intended coverage area, wherein the second encoded layer of the content item is associated with a second quality level of the content item that is greater than the first quality level of the content item.
